(19) United States
(12) Patent Application Publication
(10) Pub. No.: US 2012/0171425 A1
(43) Pub. Date: Jul. 5, 2012

(54) DISPLAY PANEL

(75) Inventors: Chih-Hsiao Tseng, Hsinchu City (TW); Yu-Chen Liu, Hsinchu City (TW); Wen-Yi Hsu, Taoyuan County (TW); Maw-Song Chen, Taipei City (TW)

(73) Assignee: AU OPTRONICS CORPORATION, Hsinchu (TW)

(21) Appl. No.: 13/154,432

(22) Filed: Jun. 6, 2011

(30) Foreign Application Priority Data
Dec. 31, 2010 (TW) 99147212

(51) Int. Cl. B32B 3/00

(52) U.S. Cl. 428/156

(57) ABSTRACT

A display panel has a display region and a peripheral region that surrounds the display region. The display panel includes a first substrate, a second substrate, a display medium, and a sealant. The first substrate has a first trench in the peripheral region, and the first trench has at least one sidewall. The second substrate is located opposite to the first substrate. The display medium is located between the first substrate and the second substrate. The sealant is located in the peripheral region between the first substrate and the second substrate. Specifically, the sealant is located in the first trench, and a distance between a sidewall of the sealant and the sidewall of the first trench ranges from about 0 um to about 700 um.

### CROSS-REFERENCE TO RELATED APPLICATION

This application claims the priority benefit of Taiwan application serial no. 99147212, filed on Dec. 31, 2010. The entirety of the above-mentioned patent application is hereby incorporated by reference herein and made a part of this specification.

### BACKGROUND OF THE INVENTION

1. Field of the Invention

The invention relates to a display panel. More particularly, the invention relates to a display panel having a slim border design.

2. Description of Related Art

In general, a liquid crystal display (LCD) panel is mainly constituted by an active device array substrate, an opposite substrate, and a liquid crystal layer sandwiched between the active device array substrate and the opposite substrate. To connect the active device array substrate and the opposite substrate, a sealant surrounding the pixel array is often formed between the active device array substrate and the opposite substrate, and the liquid crystal layer is configured within a closed space defined by the active device array substrate, the color filter substrate, and the sealant.

Besides, computer, communication, and consumer electronic products including smart phones and portable internet devices (PIDs) are mostly designed to have full touch interfaces in replacement of conventional key pads. Thereby, the active area on the screen is expanded. The intention to increase the area of the active area leads to the requirement for slim border design. At present, how to narrow the sealant in order to reduce the area of the border of the display panel is one of the research topics. In most cases, the sealant is coated onto the substrate. Given the amount of the sealant coated onto the substrate is reduced for narrowing the width of the sealant and further narrowing the border of the display panel, the sealant may be discrete during the process of coating the sealant. Namely, reduction of the amount of the sealant severely jeopardizes the quality of coating the sealant. As such, the two substrates cannot be well bonded to each other.

### SUMMARY OF THE INVENTION

The invention is directed to a display panel in which a sealant can have a reduced width without sacrificing the quality of coating the sealant, and thereby the display panel can have a slim border design.

In an embodiment of the invention, a display panel having a display region and a peripheral region that surrounds the display region is provided. The display panel includes a first substrate, a second substrate, a display medium, and a sealant. The first substrate has a first trench in the peripheral region, and the first trench has at least one sidewall. The second substrate is located opposite to the first substrate. The display medium is located between the first substrate and the second substrate. The sealant is located in the peripheral region between the first substrate and the second substrate. Specifically, the sealant is located in the first trench, and a distance between a sidewall of the sealant and the at least one sidewall of the first trench ranges from about 0 um to about 700 um.

In an embodiment of the invention, another display panel having a display region and a peripheral region that surrounds the display region is provided. The display panel includes a first substrate, a second substrate, a display medium, and a sealant. The first substrate has a first trench in the peripheral region. At least one sidewall of the first trench and a bottom of the first trench have an included angle therebetween, and the included angle ranges from about 100 degrees to about 170 degrees. The second substrate is located opposite to the first substrate. The display medium is located between the first substrate and the second substrate. The sealant is located in the peripheral region between the first substrate and the second substrate and located in the first trench.

Based on the above, in the invention, the first trench is located in the peripheral region in the first substrate, such that the sealant is configured in the first trench. The sealant is configured in the first trench, and thereby the height of the sealant can be increased without changing the coating amount of the sealant, so as to narrow the width of the sealant. The reduced width of the sealant is conducive to the slim border design of the display panel.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic top view illustrating a display panel according to an embodiment of the invention.

FIG. 2 is a schematic cross-sectional view taken along a section line I-I′ depicted in FIG. 1.

FIG. 3 to FIG. 13 are schematic cross-sectional views illustrating a portion of a display panel according to embodiments of the invention.

### DESCRIPTION OF EMBODIMENTS

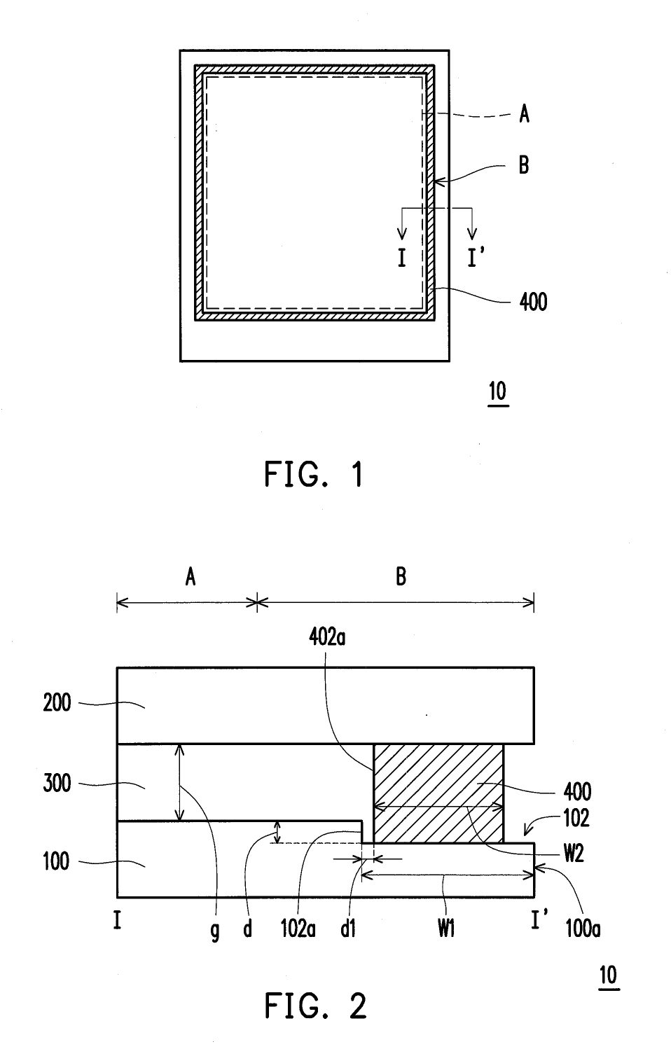

FIG. 1 is a schematic top view illustrating a display panel according to an embodiment of the invention. FIG. 2 is a schematic cross-sectional view taken along a section line I-I′ depicted in FIG. 1. With reference to FIG. 1 and FIG. 2, the display panel 10 of this embodiment has the display region A and the peripheral region B that surrounds the display region A. In general, the display region A of the display panel 10 refers to an active region that mainly serves to display images. The peripheral region B of the display panel 10 refers to a non-display region where driving elements, bonding adhesive, or film layers are disposed therein. Specifically, the peripheral region B of the display panel 10 refers to the border area. In order to narrow the border area, the width and the area of the peripheral region B need be reduced.

According to this embodiment, the display panel 10 includes a first substrate 100, a second substrate 200, a display medium 300, and a sealant 400.

The first substrate 100 can be made of glass, quartz, an organic polymer, an opaque/reflective material (e.g., a conductive material, metal, wafer, ceramics, or any other appropriate material), or any other appropriate material. Besides, a pixel array layer (not shown) is configured in the display region A in the first substrate 100. In this embodiment, the pixel array layer includes a plurality of scan lines, a plurality of data lines, and a plurality of pixel structures. Each of the pixel structures has an active device and a pixel electrode. The active device is, for instance, a bottom-gate thin film transistor (TFT) or a top-gate TFT.

In addition, the first substrate 100 has a first trench 102 in the peripheral region B, as shown in FIG. 2, and the first trench 102 has at least one sidewall 102a. The first trench 102 can be formed in the first substrate 100 by performing a well-known photolithography and etching process, a laser etching process, or any other appropriate process. According to this embodiment, the first trench 102 is formed in the peripheral region B and surrounds the entire display region A. In addition, the first trench 102 of this embodiment is an open trench, i.e., the first trench 102 has one single sidewall 102a. Hence, a distance between the first trench 102 and a side surface 100a of the first substrate 100 is 0. Here, the width W1 of the first trench 102 ranges from about 200 um to about 1500 um, and the depth d of the first trench 102 ranges from about 2 um to about 10 um.

The second substrate 200 is configured opposite to the first substrate 100. The second substrate 200 can be made of glass, quartz, an organic polymer, an opaque/reflective material (such as a conductive material, metal, wafer, ceramics, or any other appropriate material), or any other appropriate material. In addition, an electrode layer (not shown) can be configured in the display region A of the second substrate 200. The electrode layer is a transparent conductive layer, and a material of the electrode layer includes metal oxide, e.g., indium tin oxide or indium zinc oxide. According to another embodiment of the invention, a color filter array (not shown) including red, green, and blue color filter patterns can be further formed in the display area A in the second substrate 200. Moreover, a light shielding pattern layer (not shown) which is referred to as a black matrix can be further configured on the second substrate 200 and arranged between the patterns of the color filter array.

The display medium 300 is sandwiched between the first substrate 100 and the second substrate 200. The display medium 300 can include liquid crystal molecules, an electrophoretic display medium, or any other suitable display medium.

The sealant 400 is located in the peripheral region B between the first substrate 100 and the second substrate 200 and located in the first trench 102. Here, the first substrate 100 and the second substrate 200 are bonded by the sealant 400, and an accommodation space is formed between the first and second substrates 100 and 200, such that the display medium 300 can be placed in the accommodation space. Namely, the accommodation space (the area surrounded by the sealant 400 as shown in FIG. 1) defined by the first substrate 100, the second substrate 200, and the sealant 400 is filled with the display medium 300. According to this embodiment, the sealant 400 is coated into the first trench 102 of the first substrate 100 by performing a coating process, and an irradiating process or a heating process is performed to cure the sealant 400.

Specifically, the sealant 400 has a sidewall 402a and a sidewall 402b. A distance d1 between the sidewall 402a and the side wall 102a of the first trench 102 ranges from about 0 um to about 700 um. That is to say, the sealant 400 of this embodiment is located in the first trench 102, and the sidewall 402a of the sealant 400 can be in contact with or not in contact with the sidewall 102a of the first trench 102. In addition, according to this embodiment, in the display region A, the first substrate 100 and the second substrate 200 have a distance g, the first trench 100 has a depth d, and d/g=0.5˜3.5. The width W2 of the sealant 400 is substantially equal to or less than 700 um, for instance, preferably equal to or less than 500 um.

Based on the above, the first trench 102 is formed in the first substrate 100 according to this embodiment, such that the sealant 400 is formed in the first trench 102. In order to make sure that the sealant 400 is not discrete after the process for coating the sealant 400 is performed, the process for coating the sealant 400 described in this embodiment does not result in a change of the coating amount of the sealant 400. Besides, the sealant 400 of this embodiment is coated into the first trench 102. Therefore, the height of the sealant 400 can be increased, so as to narrow the width of the sealant 400 and narrow the border area (the peripheral region B) of the display panel. To be more specific, according to this embodiment, a certain distance g between the first and second substrates 100 and 200 is in the display region A of the existing display panel, and a certain coating amount of the sealant 400 in the existing display panel is given, so as to preclude the sealant 400 from being discretely coated into the first trench 102. Said design of the first trench 102 can lead to an increase in the height of the sealant 400, and thereby the width of the sealant 400 and the border area (the peripheral region B) of the display panel are both reduced.

The steps of forming the trench in the substrate and coating the sealant into the trench for narrowing the border area (the peripheral region B) of the display panel can be further embodied in various manner, as described below.

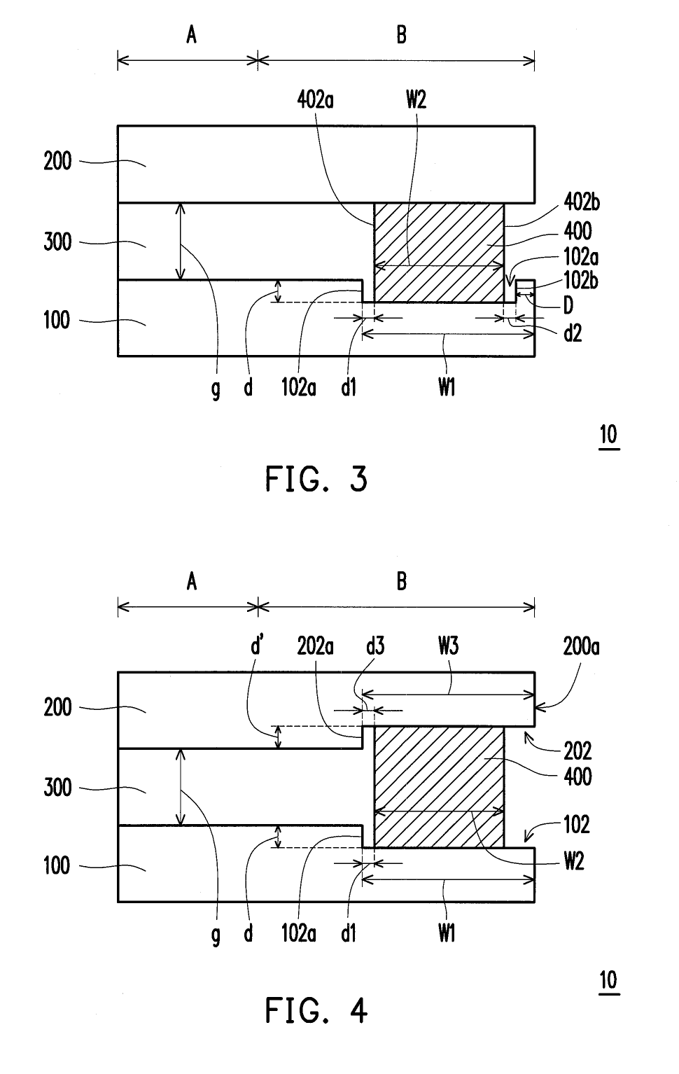

FIG. 3 is a schematic cross-sectional view illustrating a portion of a display panel according to an embodiment of the invention. With reference to FIG. 3, the embodiment depicted in FIG. 3 is similar to the embodiment depicted in FIG. 2, and the same components indicated in FIG. 3 and FIG. 2 are denoted by the same numerals and are not repeated herein. One of the differences between the embodiment depicted in FIG. 3 and the embodiment depicted in FIG. 2 lies in that the first trench 102 of the first substrate 100 in the this embodiment is a closed trench. Namely, the first trench 102 has a sidewall 102a and a sidewall 102b. The distance D between the first trench 102 and the side surface 100a of the first substrate 100 is substantially equal to or greater than 0 um and is substantially equal to or less than 500 um. The distance d1 between the sidewall 402a of the sealant 400 and the sidewall 102a of the first trench 102 ranges from about 0 um to about 700 um, preferably from about 300 um to about 500 um. The distance d2 between the other sidewall 402b of the sealant 400 and the sidewall 102b of the first trench 102 ranges from about 0 um to about 700 um, preferably from about 300 um to about 500 um. In this embodiment, the sealant 400 is located in the first trench 102. The sidewall 402a of the sealant 400 can be in contact with or not in contact with the sidewall 102a of the first trench 102. The sidewall 402b of the sealant 400 can be in contact with or not in contact with the sidewall 102b of the first trench 102.

FIG. 4 is a schematic cross-sectional view illustrating a portion of a display panel according to an embodiment of the invention. With reference to FIG. 4, the embodiment depicted in FIG. 4 is similar to the embodiment depicted in FIG. 2, and the same components indicated in FIG. 2 and FIG. 4 are denoted by the same numerals and are not repeated herein. One of the differences between the embodiment depicted in FIG. 4 and the embodiment depicted in FIG. 2 lies in that the second substrate 200 of this embodiment has a second trench 202 in the peripheral region B. The second trench 202 corresponds to the first trench 102. Preferably, the second trench 202 is aligned to the first trench 102. The second trench 202 has a sidewall 202a. Similarly, the second trench 202 can be formed in the second substrate 200 by performing a well-known photolithography and etching process, a laser etching process, or any other appropriate process. According to this embodiment, the second trench 202 is an open trench, i.e., the second trench 202 has one single sidewall 202a. Hence, the distance between the second trench 202 and a side surface 200a of the second substrate 200 is 0. The width W3 of the second trench 202 is substantially equal to the width W1 of the first trench 102 according to the embodiment. Besides, the width W3 of the second trench 202 ranges from about 200 um to about 1500 um, for instance. The depth d′ of the second trench 202 is substantially equal to the depth d of the first trench 102. The depth d of the first trench 102 and the depth d′ of the second trench 202 in total ranges from about 2 um to about 10 um, for instance.

In particular, the sealant 400 is located in the first trench 102 and the second trench 202. The distance d1 between the sidewall 402a of the sealant 400 and the sidewall 102a of the first trench 102 ranges from about 0 um to about 700 um, preferably from about 300 um to about 500 um. The distance d3 between the sidewall 402a of the sealant 400 and the sidewall 202a of the second trench 202 ranges from about 0 um to about 700 um, preferably from about 300 um to about 500 um. Namely, the sidewall 402a of the sealant 400 can be in contact with or not in contact with the sidewall 102a of the first trench 102 according to this embodiment; the sidewall 402a of the sealant 400 can be in contact with or not in contact with the sidewall 202a of the second trench 202 according to this embodiment. In addition, according to this embodiment, the first substrate 100 and the second substrate 200 in the display region A have a distance g therebetween, the first trench 102 has a depth d, the second trench 202 has a depth d′, and (d+d′)/g=0.5˜3.5.

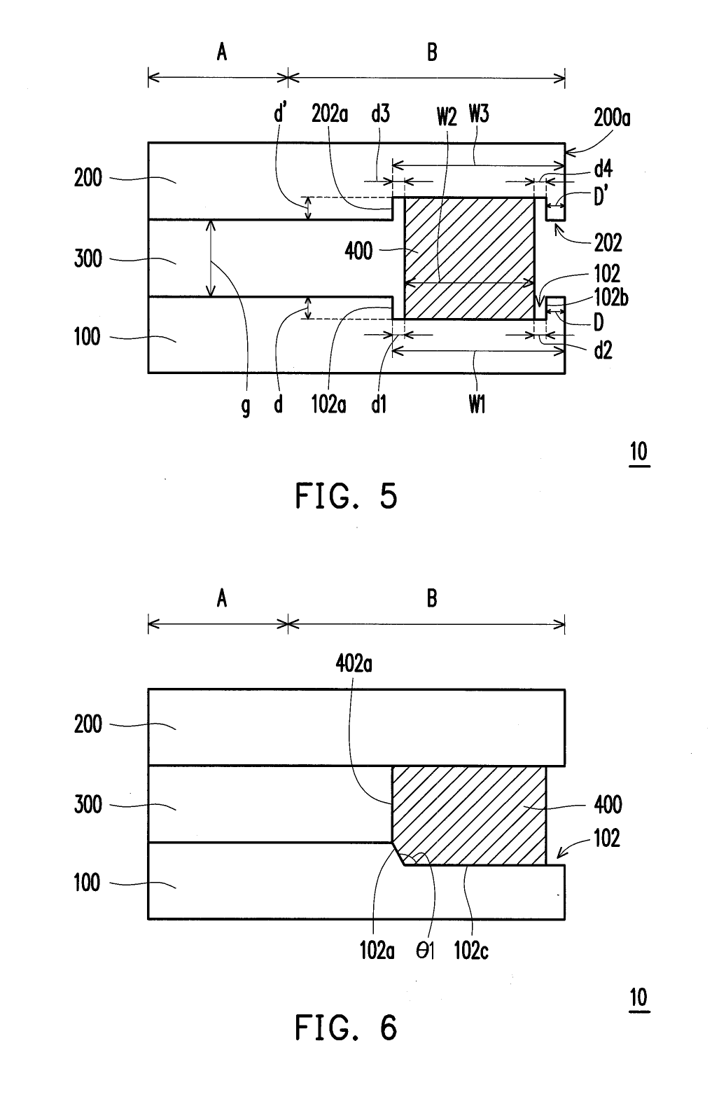

FIG. 5 is a schematic cross-sectional view illustrating a portion of a display panel according to an embodiment of the invention. With reference to FIG. 5, the embodiment depicted in FIG. 3 is similar to the embodiment depicted in FIG. 5, and the same components indicated in FIG. 3 and FIG. 5 are denoted by the same numerals and are not repeated herein. One of the differences between the embodiment depicted in FIG. 5 and the embodiment depicted in FIG. 3 lies in that the second substrate 200 has a second trench 202 in the peripheral region B. The second trench 202 corresponds to the first trench 102. Preferably, the second trench 202 is aligned to the first trench 102. The second trench 202 is a closed trench as well. In other words, the second trench 202 has a first sidewall 202a and a second sidewall 202b. The distance D′ between the second trench 202 and the side surface 200a of the second substrate 200 is substantially equal to or less than 500 um. The width W3 of the second trench 202 is substantially equal to the width W1 of the first trench 102 according to the embodiment. Particularly, the width W3 of the second trench 202 ranges from about 200 um to about 1500 um, for instance. The depth d′ of the second trench 202 is substantially equal to the depth d of the first trench 102. The depth d of the first trench 102 and the depth d′ of the second trench 202 in total ranges from about 2 um to about 10 um, for instance. The distance d3 between the sidewall 402a of the sealant 400 and the first sidewall 202a of the second trench 202 ranges from about 0 um to about 700 urn, preferably from about 300 um to about 500 um. The distance d4 between the other sidewall 402b of the sealant 400 and the second sidewall 202b of the second trench 202 ranges from about 0 um to about 700 um, preferably from about 300 um to about 500 um. Accordingly, the sealant 400 of this embodiment is located in the first trench 102 and the second trench 202. The sidewall 402a of the sealant 400 can be in contact with or not in contact with the sidewall 102a of the first trench 102 and the sidewall 202a of the second trench 202. The sidewall 402b of the sealant 400 can be in contact with or not in contact with the sidewall 102b of the first trench 102 and the sidewall 202b of the second trench 202.

FIG. 6 is a schematic cross-sectional view illustrating a portion of a display panel according to an embodiment of the invention. With reference to FIG. 6, the embodiment depicted in FIG. 6 is similar to the embodiment depicted in FIG. 2, and the same components indicated in FIG. 6 and FIG. 2 are denoted by the same numerals and are not repeated herein. One of the differences between the embodiment depicted in FIG. 6 and the embodiment depicted in FIG. 2 lies in that the sidewall 102a of the first trench 102 and the bottom 102c of the first trench 102 have an included angle θ1 therebetween, and the included angle θ1 ranges from about 100 degrees to about 170 degrees. In other words, the included angle θ1 between the sidewall 102a and the bottom 102c of the first trench 102 is an obtuse angle in this embodiment. The sealant 400 is configured in the first trench 102 and is in contact with the sidewall 102a of the first trench 102. Since the sidewall 102a and the bottom 102c of the first trench 102 have the obtuse included angle therebetween in this embodiment, the first trench 102a has a relatively large accommodation space in comparison with other trenches that have the perpendicular sidewalls. Consequently, the width of the sealant 400 configured in the first trench 102 can be further narrowed, such that the border area (the peripheral region B) of the display panel can be reduced.

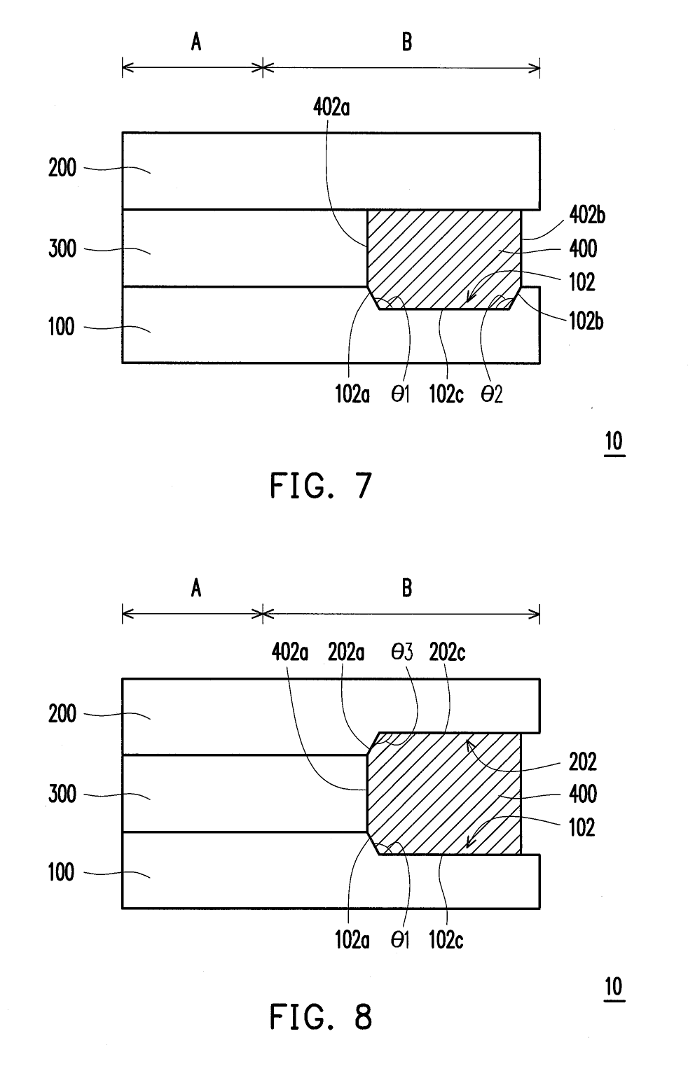

FIG. 7 is a schematic cross-sectional view illustrating a portion of a display panel according to an embodiment of the invention. With reference to FIG. 7, the embodiment depicted in FIG. 7 is similar to the embodiment depicted in FIG. 6, and the same components indicated in FIG. 7 and FIG. 6 are denoted by the same numerals and are not repeated herein. One of the differences between the embodiment depicted in FIG. 7 and the embodiment depicted in FIG. 6 lies in that the first trench 102 of this embodiment has the sidewalls 102a and 102b, the sidewall 102a of the first trench 102 and the bottom 102c of the first trench 102 have an included angle θ1 therebetween, and the included angle θ1 ranges from about 100 degrees to about 170 degrees. In addition, the sidewall 102b of the first trench 102 and the bottom 102c of the first trench 102 have an included angle θ2 therebetween, and the included angle θ2 ranges from about 100 degrees to about 170 degrees. In other words, the included angle θ1 between the sidewall 102a and the bottom 102c of the first trench 102 is an obtuse angle in this embodiment, and the included angle θ2 between the sidewall 102b and the bottom 102c of the first trench 102 is an obtuse angle as well. The sealant 400 is configured in the first trench 102 and is in contact with the sidewalls 102a and 102b of the first trench 102. Consequently, the width of the sealant 400 configured in the first trench 102 can be further narrowed, such that the border area (the peripheral region B) of the display panel can be reduced.

FIG. 8 is a schematic cross-sectional view illustrating a portion of a display panel according to an embodiment of the invention. With reference to FIG. 8, the embodiment depicted in FIG. 8 is similar to the embodiment depicted in FIG. 6, and the same components indicated in FIG. 8 and FIG. 6 are denoted by the same numerals and are not repeated herein. One of the differences between the embodiment depicted in FIG. 8 and the embodiment depicted in FIG. 6 lies in that the second substrate 200 of this embodiment has a second trench 202 in the peripheral region B. The second trench 202 corresponds to the first trench 102. Preferably, the second trench 202 is aligned to the first trench 102. The second trench 202 has a second sidewall 202a, the sidewall 202a and the bottom 202c of the second trench 202 have an included angle θ3 therebetween, and the included angle θ3 ranges from about 100 degrees to about 170 degrees. Namely, the included angle θ3 between the sidewall 202a and the bottom 202c of the second trench 202 in this embodiment is an obtuse angle. The sealant 400 is configured in the first trench 102 and the second trench 202 and is in contact with the sidewall 102a of the first trench 102 and the sidewall 202a of the second trench 202. Consequently, the width of the sealant 400 configured in the first trench 102 and the second trench 202 can be further narrowed, such that the border area (the peripheral region B) of the display panel can be reduced.

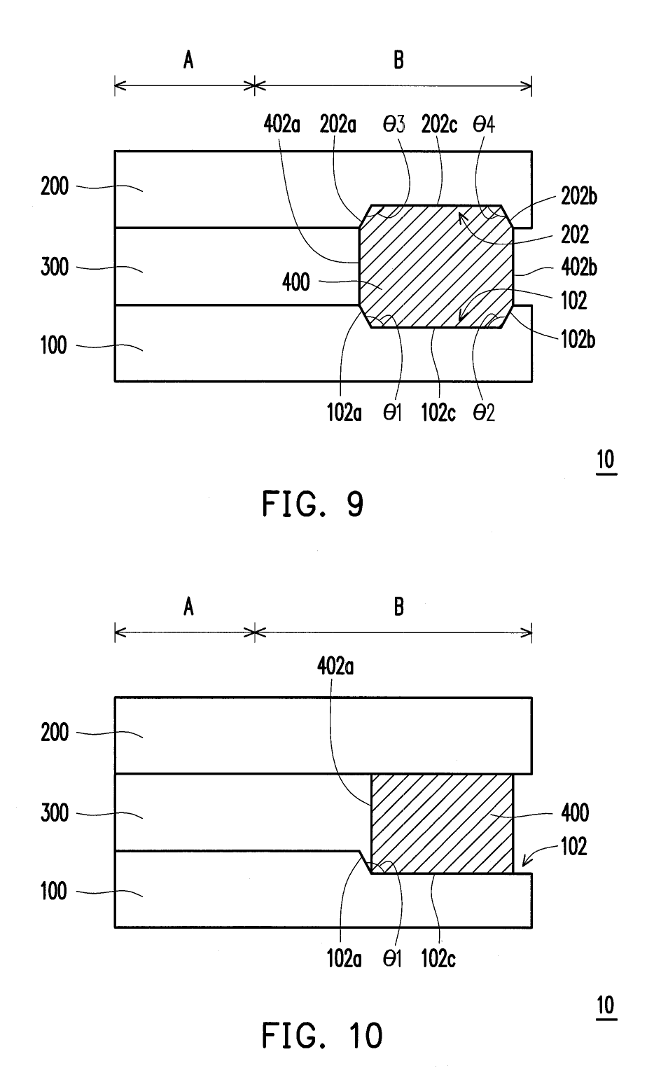

FIG. 9 is a schematic cross-sectional view illustrating a portion of a display panel according to an embodiment of the invention. With reference to FIG. 9, the embodiment depicted in FIG. 7 is similar to the embodiment depicted in FIG. 9, and the same components indicated in FIG. 9 and FIG. 7 are denoted by the same numerals and are not repeated herein. One of the differences between the embodiment depicted in FIG. 9 and the embodiment depicted in FIG. 7 lies in that the second substrate 200 of this embodiment has a second trench 202 in the peripheral region B. The second trench 202 corresponds to the first trench 102. Preferably, the second trench 202 is aligned to the first trench 102. The second trench 202 has the sidewalls 202a and 202b, the sidewall 202a and the bottom 202c have an included angle θ3 therebetween, and the included angle θ3 ranges from about 100 degrees to about 170 degrees. The sidewall 202b and the bottom 202c of the second trench 202 have an included angle θ4 therebetween, and the included angle θ4 ranges from about 100 degrees to about 170 degrees. The sealant 400 is configured in the first trench 102 and the second trench 202 and is in contact with the sidewalls 102a and 102b of the first trench 102 and the sidewalls 202a and 202b of the second trench 202. Consequently, the width of the sealant 400 configured in the first trench 102 and the second trench 202 can be further narrowed, such that the border area (the peripheral region B) of the display panel can be reduced.

FIG. 10 is a schematic cross-sectional view illustrating a portion of a display panel according to an embodiment of the invention. With reference to FIG. 10, the embodiment depicted in FIG. 6 is similar to the embodiment depicted in FIG. 10, and the same components indicated in FIG. 10 and FIG. 6 are denoted by the same numerals and are not repeated herein. One of the differences between the embodiment depicted in FIG. 10 and the embodiment depicted in FIG. 6 lies in that the distance between the sidewall 102a of the first trench 102 and the sidewall 402a of the sealant 400 ranges from about 0 um to about 700 um, preferably from about 300 um to about 500 um. Namely, the sidewall 102a and the bottom 102c of the first trench 102a have the obtuse included angle therebetween, and the sidewall 102a of the first trench 102 is likely not to be in contact with the sidewall 402a of the sealant 400.

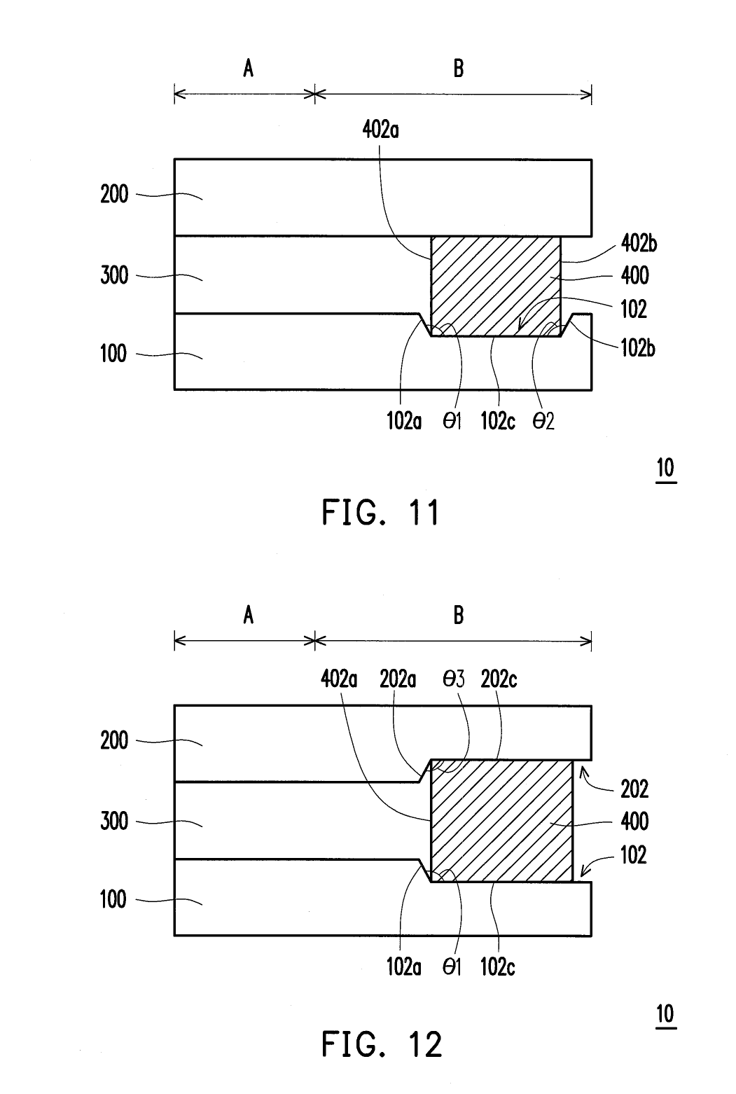

FIG. 11 is a schematic cross-sectional view illustrating a portion of a display panel according to an embodiment of the invention. With reference to FIG. 11, the embodiment depicted in FIG. 7 is similar to the embodiment depicted in FIG. 11, and the same components indicated in FIG. 11 and FIG. 7 are denoted by the same numerals and are not repeated herein. One of the differences between the embodiment depicted in FIG. 11 and the embodiment depicted in FIG. 7 lies in that the distance between the sidewall 102a of the first trench 102 and the sidewall 402a of the sealant 400 ranges from about 0 um to about 700 um, preferably from about 300 um to about 500 um, and that the distance between the sidewall 102b of the first trench 102 and the sidewall 402b of the sealant 400 ranges from about 0 um to about 700 um, preferably from about 300 um to about 500 um. In other words, according to this embodiment, the sidewall 102a and the bottom 102c of the first trench 102 have the included angle θ1 ranging from about 100 degrees to about 170 degrees, and the sidewall 102b and the bottom 102c of the first trench 102 have an included angle θ2 ranging from about 100 degrees to about 170 degrees. Moreover, the sidewall 102a of the first trench 102 is likely not to be in contact with the sidewall 402a of the sealant 400, and the sidewall 102b is likely not to be in contact with the sidewall 402a of the sealant 400.

FIG. 12 is a schematic cross-sectional view illustrating a portion of a display panel according to an embodiment of the invention. With reference to FIG. 12, the embodiment depicted in FIG. 8 is similar to the embodiment depicted in FIG. 12, and the same components indicated in FIG. 12 and FIG. 8 are denoted by the same numerals and are not repeated herein. One of the differences between the embodiment depicted in FIG. 12 and the embodiment depicted in FIG. 8 lies in that the distance between the sidewall 102a of the first trench 102 and the sidewall 402a of the sealant 400 ranges from about 0 um to about 700 um, preferably from about 300 um to about 500 um, and that the distance between the sidewall 202a of the second trench 202 and the sidewall 402a of the sealant 400 ranges from about 0 um to about 700 um, preferably from about 300 um to about 500 um. In other words, the sidewall 102a and the bottom 102c of the first trench 102 have the included angle θ1 ranging from about 100 degrees to about 170 degrees, and the sidewall 202a and the bottom 202c of the second trench 202 have an included angle θ2 ranging from about 100 degrees to about 170 degrees. Moreover, the sidewall 102a of the first trench 102 is likely not to be in contact with the sidewall 402a of the sealant 400, and the sidewall 202a of the second trench 202 is likely not to be in contact with the sidewall 402a of the sealant 400.

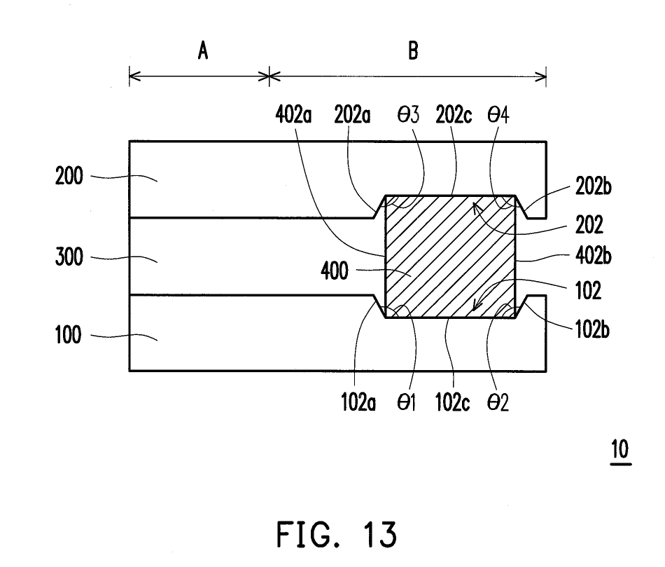

FIG. 13 is a schematic cross-sectional view illustrating a portion of a display panel according to an embodiment of the invention. With reference to FIG. 13, the embodiment depicted in FIG. 9 is similar to the embodiment depicted in FIG. 13, and the same components indicated in FIG. 13 and FIG. 9 are denoted by the same numerals and are not repeated herein. One of the differences between the embodiment depicted in FIG. 13 and the embodiment depicted in FIG. 9 lies in that the distance between the sidewall 102a of the first trench 102 and the sidewall 402a of the sealant 400 ranges from about 0 um to about 700 um, preferably from about 300 um to about 500 um. Besides, the distance between the sidewall 102b of the first trench 102 and the sidewall 402b of the sealant 400 ranges from about 0 um to about 700 um, preferably from about 300 um to about 500 um. The distance between the sidewall 202a of the second trench 202 and the sidewall 402a of the sealant 400 ranges from about 0 um to about 700 um, preferably from about 300 um to about 500 um. The distance between the sidewall 202b of the second trench 202 and the sidewall 402b of the sealant 400 ranges from about 0 um to about 700 um, preferably from about 300 um to about 500 um. Namely, in this embodiment, the sidewall 102a and the bottom 102c of the first trench 102 have an included angle θ1 therebetween, and the included angle θ1 ranges from about 100 degrees to about 170 degrees. Besides, the sidewall 102b and the bottom 102c of the first trench 102 have an included angle θ2 therebetween, and the included angle θ2 ranges from about 100 degrees to about 170 degrees. The sidewall 202a and the bottom 202c of the second trench 202 have an included angle θ3 therebetween, and the included angle θ3 ranges from about 100 degrees to about 170 degrees. The sidewall 202b and the bottom 202c of the second trench 202 have an included angle θ4, and the included angle θ4 ranges from about 100 degrees to about 170 degrees. Moreover, the sidewalls 102a and 102b of the first trench 102 are likely not to be in contact with the sidewalls 402a and 402b of the sealant 400, and the sidewalls 202a and 202b of the second trench 202 are likely not to be in contact with the sidewalls 402a and 402b of the sealant 400.

In light of the foregoing, the trench is located in the peripheral region in the substrate, such that the sealant is configured in the trench. The sealant is configured in the trench, and thereby the height of the sealant can be increased without changing the coating amount of the sealant, so as to narrow the width of the sealant. The reduced width of the sealant is conducive to the slim border design of the display panel.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display panel having a display region and a peripheral region surrounding the display region, the display panel comprising:
a first substrate having a first trench in the peripheral region, the first trench having at least one sidewall;
a second substrate located opposite to the first substrate;
a display medium located between the first substrate and the second substrate; and
a sealant located in the peripheral region between the first substrate and the second substrate and located in the first trench, wherein a distance between a sidewall of the sealant and the at least one sidewall of the first trench ranges from about 0 um to about 700 um.

2. The display panel as claimed in claim 1, wherein the at least one side wall of the first trench and a bottom of the first trench have an included angle therebetween, and the included angle ranges from about 100 degrees to about 170 degrees.

3. The display panel as claimed in claim 1, wherein the at least one sidewall of the first trench comprises a first sidewall and a second sidewall, a distance between the sidewall of the sealant and the first sidewall ranges from about 0 um to about 700 um, and a distance between the other sidewall of the sealant and the second sidewall ranges from about 0 um to about 700 um.

4. The display panel as claimed in claim 1, wherein the at least one sidewall of the first trench comprises a first sidewall and a second sidewall, a distance between the sidewall of the sealant and the first sidewall ranges from about 300 um to about 500 um, and a distance between the other sidewall of the sealant and the second sidewall ranges from about 300 um to about 500 um.

5. The display panel as claimed in claim 1, wherein the at least one sidewall of the first trench comprises a first sidewall and a second sidewall, an included angle is between each of the first sidewall and the second sidewall of the first trench and a bottom of the first trench, and the included angle ranges from about 100 degrees to about 170 degrees.

6. The display panel as claimed in claim 1, wherein a distance (g) is between the first substrate and the second substrate in the display region, the first trench has a depth (d), and d/g=0.5˜3.5.

7. The display panel as claimed in claim 1, wherein a width of the first trench ranges from about 200 um to about 1500 um.

8. The display panel as claimed in claim 1, wherein a depth of the first trench ranges from about 2 um to about 10 um.

9. The display panel as claimed in claim 1, wherein a distance between the first trench and a side surface of the first substrate ranges from about 0 um to about 500 um.

10. The display panel as claimed in claim 1, wherein a width of the sealant is substantially equal to or less than 500 um.

11. The display panel as claimed in claim 1, wherein the second substrate has a second trench in the peripheral region, the second trench has at least one sidewall, the sealant is located in the second trench, and a distance between the sidewall of the sealant and the at least one sidewall of the second trench ranges from about 0 um to about 700 um.

12. The display panel as claimed in claim 1, wherein the second substrate has a second trench in the peripheral region, the second trench has at least one sidewall, the sealant is located in the second trench, and a distance between the sidewall of the sealant and the at least one sidewall of the second trench ranges from about 300 um to about 500 um.

13. The display panel as claimed in claim 1, wherein the second substrate has a second trench in the peripheral region, the second trench has at least one sidewall, the at least one sidewall of the second trench and a bottom of the second trench have an included angle therebetween, and the included angle ranges from about 100 degrees to about 170 degrees.

14. The display panel as claimed in claim 1, wherein the second substrate has a second trench in the peripheral region, the second trench has a third sidewall and a fourth sidewall, a distance between the sidewall of the sealant and the third sidewall ranges from about 0 um to about 700 um, and a distance between the other sidewall of the sealant and the fourth sidewall ranges from about 0 um to about 700 um.

15. The display panel as claimed in claim 1, wherein the second substrate has a second trench in the peripheral region, the second trench has a third sidewall and a fourth sidewall, a distance between the sidewall of the sealant and the third sidewall ranges from about 300 um to about 500 um, and a distance between the other sidewall of the sealant and the fourth sidewall ranges from about 300 um to about 500 um.

16. The display panel as claimed in claim 1, wherein the second substrate has a second trench in the peripheral region, the second trench has a third sidewall and a fourth sidewall, an included angle is between each of the third sidewall and the fourth sidewall of the second trench and a bottom of the second trench, and the included angle ranges from about 100 degrees to about 170 degrees.

17. The display panel as claimed in claim 1, wherein the second substrate has a second trench in the peripheral region, and a width of the second trench is substantially equal to a width of the first trench.

18. The display panel as claimed in claim 1, wherein the second substrate has a second trench in the peripheral region, and a depth of the second trench is substantially equal to a depth of the first trench.

19. A display panel having a display region and a peripheral region surrounding the display region, the display panel comprising:
a first substrate having a first trench in the peripheral region, wherein at least one sidewall of the first trench and a bottom of the first trench have an included angle therebetween, and the included angle ranges from about 100 degrees to about 170 degrees;
a second substrate located opposite to the first substrate;
a display medium located between the first substrate and the second substrate; and
a sealant located in the peripheral region between the first substrate and the second substrate and located in the first trench.

20. The display panel as claimed in claim 19, wherein a distance (g) is between the first substrate and the second substrate in the display region, the first trench has a depth (d), and d/g=0.5˜3.5.

21. The display panel as claimed in claim 19, wherein a width of the first trench ranges from about 200 um to about 1500 um.

22. The display panel as claimed in claim 19, wherein a depth of the first trench ranges from about 2 um to about 10 um.

23. The display panel as claimed in claim 19, wherein a distance between the first trench and a side surface of the first substrate ranges from about 0 um to about 500 um.

24. The display panel as claimed in claim 19, wherein a width of the sealant is substantially equal to or less than 700 um.

25. The display panel as claimed in claim 19, wherein a width of the sealant is substantially equal to or less than 500 um.

26. The display panel as claimed in claim 19, wherein the second substrate has a second trench in the peripheral region, at least one sidewall of the second trench and a bottom of the second trench have an included angle therebetween, and the included angle ranges from about 100 degrees to about 170 degrees.

27. The display panel as claimed in claim 19, wherein the second substrate has a second trench in the peripheral region, and a width of the second trench is substantially equal to a width of the first trench.

28. The display panel as claimed in claim 19, wherein the second substrate has a second trench in the peripheral region, and a depth of the second trench is substantially equal to a depth of the first trench.
